(19) United States
(12) Patent Application Publication
(10) Pub. No.: US 2009/0160646 A1
(43) Pub. Date: Jun. 25, 2009

(54) SYSTEM AND METHOD FOR MONITORING AND TRACKING INVENTORIES

(75) Inventors: Patricia Denise Mackenzie, Clifton Park, NY (US); Judith Ann Guzzo, Niskayuna, NY (US); Joseph James Salvo, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/961,533

(22) Filed: Dec. 20, 2007

(51) Int. Cl. G08B 13/14; G08B 23/00

(52) U.S. Cl. 340/572.1; 340/500; 340/686.1; 340/545.1; 340/602; 340/584; 340/600

(57) ABSTRACT

A technique is provided for monitoring and tracking inventories within one or more assets. The technique includes sensing a plurality of parameters associated with each of the one or more assets. The plurality of parameters includes a positional information of the asset. The technique further includes activating RFID tags attached to the inventories and generating a response based upon the responses received from the RFID tags, and monitoring and tracking inventories based on the sensed parameters and the generated response to ensure integrity and validate a chain of custody of the asset or the inventories during a supply chain process.

### BACKGROUND

The invention relates generally to supply chain management, and more specifically to monitoring and tracking of pharmaceutical inventories during the entire supply chain process for ensuring pharmaceutical safety and integrity.

Monitoring and tracking inventories and/or assets at each step of a supply chain process have long been areas of focus for businesses that ship a large number of products or materials to a variety of customer locations. This is particularly important for inventories that have low shelf life and/or that are prone to theft, counterfeiting, environmental exposure, and so forth. For example, pharmaceutical businesses generally face challenges related to ensuring safety and integrity of drugs. Counterfeit drugs, drug diversion and drug authentication are ongoing challenges in the pharmaceutical supply chain. Conventionally, monitoring and tracking inventories involved manual inspection and record maintenance through paper trails related to the inventories or through unique computer-readable identification codes (e.g. bar codes) placed on the inventories. By recording/scanning these and inspecting inventories at various checkpoints during delivery, safety and integrity of the inventories may be ensured. Unfortunately, this process requires the affirmative step of recording or scanning each identification code in a timely manner. Further, these techniques lead to unnecessary delay in the supply chain process.

In the absence of a suitable monitoring and tracking technique for drugs, the problems of counterfeit drugs getting into the market, drug diversion to black markets via theft, and drug integrity and authentication are all increasing according to the FDA. The FDA has therefore formulated many guidelines to curb this. For example, the FDA has required RFID labeling of certain drugs. Many pharmaceutical companies have taken this further, requiring more drugs to be tagged. However, these solutions only provide local identification of the drug. They do not provide global tracking. Also, as stand-alone systems, they can be fairly easily spoofed. That is, an RFID label can be altered or re-applied to a “fake” drug, while the real drug is diverted. Alternatively, counterfeit RFID labels could be applied to drugs manufactured in non-approved facilities, making those products appear to be authentic. Thus, the technique is not sufficiently broad-based and robust for real life problems.

Moreover, current techniques fail to provide information regarding environmental conditions around the inventories and/or state of the inventories during transit. For example, once an inventory tagged with RFID leaves the manufacturing facility and is loaded into the trailer, the tagged inventory cannot be tracked or monitored. This is particularly important as more and more companies are relying on trailers or mobile assets to act as a mobile warehouse for them. Thus, there is a need to get real time information of where and how the inventories and/or assets are at any point in time and their condition.

It is therefore desirable to provide a technique for tracking and/or monitoring inventories in an automated, efficient, accurate and cost-effective fashion from their point of shipment to their point of delivery. Additionally, it is desirable to provide a robust tracking and/or monitoring system for enabling an integrated solution for a number of specific customer needs, such as: tracking mobile assets; tracking and/or monitoring inventories within these mobile assets; providing validation of pickups and deliveries; providing visibility into the capacity of the mobile assets; and providing visibility into the condition and location of the inventories and/or assets anywhere in the world and making that information available to the customer.

### BRIEF DESCRIPTION

Briefly, in accordance with one aspect of the technique, a system is provided for monitoring and tracking inventories within one or more assets. The system includes a plurality of sensors disposed within each of the one or more assets and configured to sense corresponding parameters. The plurality of sensors includes a position sensor configured to receive positional information of the respective asset. The system also includes one or more RFID readers configured to communicate with RFID tags attached to the inventories upon being activated and to generate a response. The system further includes a processor in communication with the one or more RFID readers and the plurality of sensors and configured to monitor and track inventories based on the sensed parameters and the generated response and to analyze the sensed parameters and the generated response to ensure integrity and validate a chain of custody of the asset or the inventories during entire period of monitoring and tracking.

In accordance with another aspect of the technique, a smart asset is provided. The smart asset includes a plurality of sensors configured to sense corresponding parameters, one or more RFID readers configured to detect presence of inventories tagged with RFID tags within the smart asset upon being activated and to generate a response upon detection, and a communication device configured to relay the sensed parameters and the generated response received from the plurality of sensors and the one or more RFID readers to a processor. The processor is configured to analyze the sensed parameters and the generated response to ensure integrity and validate a chain of custody of the asset or the inventories during a supply chain process.

In accordance with an additional aspect of the technique, a method is provided for monitoring and tracking inventories within one or more assets. The method provides for sensing a plurality of parameters associated with each of the one or more assets, activating RFID tags attached to the inventories and generating a response based upon the responses received from the RFID tags, and monitoring and tracking inventories based on the sensed parameters and the generated response to ensure integrity and validate a chain of custody of the asset or the inventories during a supply chain process. The plurality of parameters includes a positional information of the asset. Systems and computer programs that afford such functionality may be provided by the present technique.

In accordance with a further aspect of the technique, a method is provided for monitoring chain of custody of an inventory. The method provides for registering the inventory with an asset, monitoring integrity of the asset, and monitoring integrity of the inventory based on the asset monitoring. Here again, systems and computer programs affording such functionality may be provided by the present technique.

### DRAWINGS

These and other features, aspects, and advantages of the present invention will become better understood when the following detailed description is read with reference to the accompanying drawings in which like characters represent like parts throughout the drawings, wherein:

FIGS. 1 and 2 are a schematic diagram of a system for monitoring and/or tracking inventories during entire supply chain in accordance with aspects of the present technique;

FIG. 3 depicts a control scheme for tracking and monitoring inventories within one or more assets in accordance with aspects of the present technique; and

FIG. 4 depicts a control scheme for monitoring chain of custody of an inventory in accordance with aspects of the present technique.

### DETAILED DESCRIPTION

The present techniques are generally directed to wireless tracking and/or monitoring of inventories. Such tracking and/or monitoring techniques may be useful in tracking and/or monitoring inventories at each step of a supply chain process, such as at manufacturing facility, during transit, at distribution centers or warehouses, at retail stores, and so forth. Though the present discussion provides examples in context of in-transit tracking and/or monitoring, one of ordinary skill in the art will readily apprehend that the application of these techniques in other contexts, such as for tracking and/or monitoring inventories at manufacturing facilities, warehouses, distribution center and retail stores, is well within the scope of the present techniques.

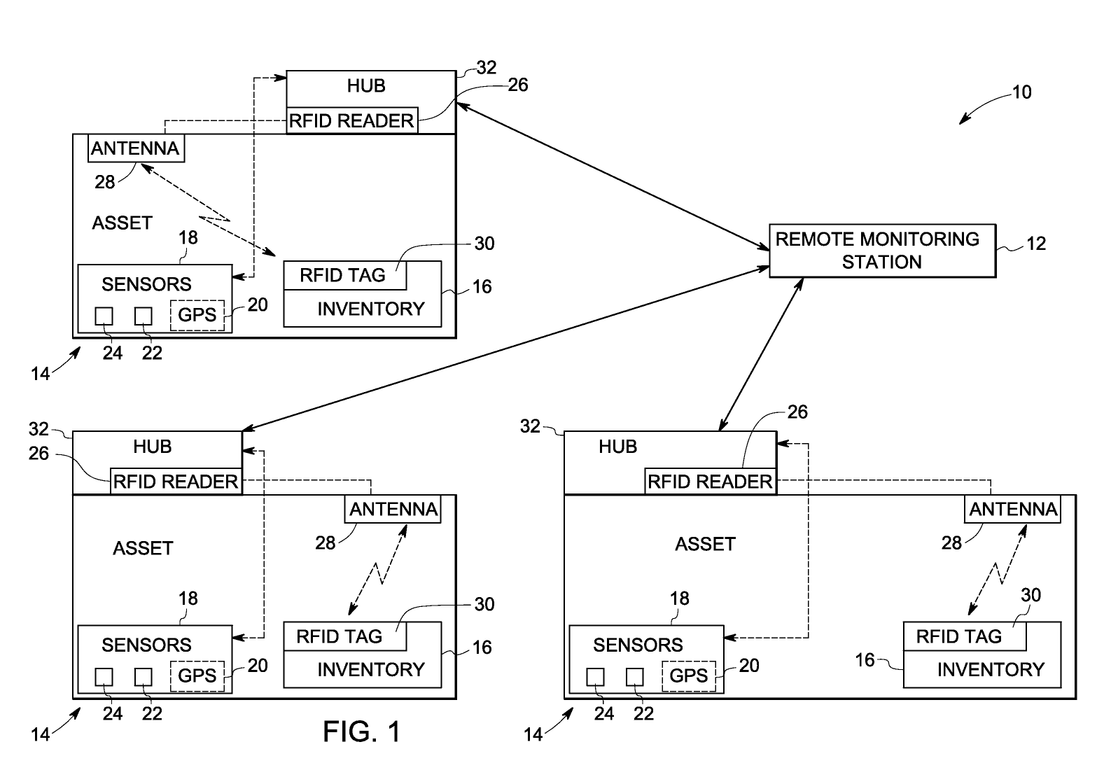

Referring now to FIGS. 1 and 2, a schematic diagram of an exemplary system 10 for monitoring and tracking inventories within one or more assets (e.g., trailers) during entire supply chain is illustrated in accordance with aspects of the present technique. The system 10 includes a monitoring station 12 for monitoring and tracking one or more assets 14 and one or more inventories 16 disposed within the one more assets 14. In certain embodiments, the monitoring may be performed at a remote and/or centralized monitoring station. Further, in certain embodiments, the one or more assets 14 may be mobile assets that may be employed to deliver inventories 16 from one place to another. These mobile assets may include trailers, cargo containers shipped by boat, rail boxcars, and so forth. Alternatively, the one or more assets 14 may be a manufacturing facility, a warehouse, a distribution center or a retail store where the inventories 16 may be temporarily stationed. Further, it should be noted that the inventories may include pharmaceutical inventories such as drugs.

Each of the one or more assets 14 may be equipped with a plurality of sensors 18 to sense various parameters related to the asset 14 and the inventories 16. These sensors 18 may be adapted to detect events (e.g., door open and close event), positional information, environmental conditions (e.g., humidity, temperature, radiation, chemical and so forth) and mechanical impact (e.g., tire pressure, shock and so forth), among other things. For example, each of the assets 14 may be equipped with a position sensing or locating device 20 that receives positional information of the asset 14. It should be noted that the position sensing device 20 may be adapted to track the location of the mobile asset either throughout the transit or only upon being activated. The position sensing (locating) device 20 may include one or more of a GPS-based position sensing device, a TV-based position sensing device, a TV-GPS based position sensing device, a wireless access point network-based position sensing device, and/or a GSM network-based position sensing device. These position sensing devices 20 utilize TV signals, GPS signals, GSM signals, or wireless network signals for determining positional information of the mobile asset being tracked.

Further, each of the assets 14 may be equipped with door sensors 22 for detecting door open and close events, thereby indicating whether the door is in open position or closed position. Similarly, pressure sensors 24 may indicate pressure in the tires of the trailer. Other sensors may include shock sensors to detect mechanical shock or impact, humidity sensors to indicate humidity level within the assets, temperature sensors to indicate temperature within the assets, radiation sensors to indicate the radiation level within the assets, and/or chemical sensors to indicate presence of certain chemicals in the inventories. It should be noted that other sensors may also be employed by the present technique for detecting other parameters that might be of interest to a user.

Additionally, each of the one or more assets 14 may be equipped with one or more RFID readers 26 and one or more antennas 28 coupled to the one or more RFID readers 26 for monitoring inventories 16 within the asset 14 as will be described in greater detail below. The one or more antennas 28 may be placed at a plurality of locations within the asset 14. The plurality of antennas 28 are adapted to receive responses from one or more RFID tags 30 upon being activated by the RFID readers 26 and relay the responses to the corresponding RFID readers 26. Alternatively, the RFID readers 26 may be adapted to read and/or scan the RFID tags 30 directly. Thus, the RFID reader 26 may activate and receive response from the RFID tags 30. As will be appreciated by one skilled in the art, the RFID tags 30 are affixed or attached to each of the inventories 16 being tracked or monitored.

Each of the assets 14 further includes a remote hub 32 that is in communication with the sensors 18 (e.g., position sensing device 20, door sensors 22, pressure sensors 24 and so forth), the RFID readers 26 and the monitoring station 12. Additionally, the remote hubs 32 may be in direct communication with each other. In certain embodiments, the remote hub 32 receives a request from the monitoring station 12, activates or initiates the sensors 18 and the RFID readers 26, receives response data from the sensors 18 and the RFID readers 26, processes/analyzes sensed parameters and response data, transmits the received data, a subset of the received data, or the analyzed data to the monitoring station 12, and so forth. Thus, the remote hub 32 acts as a link between the sensors 18 and the RFID readers 26 mounted on or within the asset 14 and the monitoring station 12. Additionally, in certain embodiments, the remote hub 32 may monitor the sensors 18 and the RFID reader 26 at regular or user-defined intervals and may initiate an alarm or may relay an exception or anomaly reports to the monitoring station 12 upon detecting exceptions or anomalies.

The monitoring station 12 may request (activate/initiate) the hub 32 which in turn may request the RFID reader 26 to find a tagged inventory 16 within the asset 14. The RFID reader 26 upon receiving request emits a radio frequency (rf) signals 34 or activates the plurality of antennas via an activation signal that then emits radio frequency (rf) signals 34. The RFID tags 30 attached to the inventories 16 receive the rf signal 34 and responds back with rf signal 36 comprising its unique identification code and other encoded data (e.g., batch number, date of manufacturing, date of expiry, and so forth). Additionally, it should be noted that, the RFID tags 30 may have integrated or inbuilt sensors (e.g., temperature sensor, humidity sensor, and so forth) and may therefore relay sensed data (e.g., temperature, humidity level, and so forth) along with identification data and other encoded data. The readers 26 receive the response 36 from the RFID tags 30 (directly or through the plurality of antennas) and relay the response data (RFID data) to the hub 32. The hub 32 may then relay the information to the monitoring station 12 over a wireless or satellite communication network. The monitoring station 12 may then analyze the response to determine the presence and the location of the RFID tag 30 (if present). Alternatively, the hub may analyze the response to determine the presence and the location of the RFID tag 30 and relay the result to the monitoring station 12.

The remote hub 32 may include a communication device for receiving and transmitting signals from and to the monitoring station 12 and/or the other hubs 32 over a wired, a wireless, or a satellite communication network. The communication device may include one or more of an Ethernet port, a USB port, IEEE 1394 port, a GSM-based communication device, a GPRS-based communication device, a wireless communication device, a device configured to communicate with communication satellites (e.g., low earth orbit satellites, geo-stationary satellites, etc.), or other devices known to one skilled in the art. Additionally, the remote hub 32 is configured to communicate with the sensors 18 and/or the RFID readers 26 over a wired or a wireless communication network (e.g., Bluetooth, Zigbee, WiFi, IEEE 802.15.4, etc.). It should be noted that, in certain embodiments, the some of the sensors 18 (e.g., position sensing device 20) and/or the RFID readers 26 may be integrated into the remote hub 32. As will be appreciated by those skilled in the art, the remote hub 32 may be a VeriWise™ hub or a modified VeriWise™ hub, produced by the General Electric Company. Further, in certain embodiments, the remote hub 32 may include a processor for processing or analyzing the response received from the sensors 18 and/or the RFID readers 26 and determining the location of the asset and/or the presence of the inventory within the asset based on the analysis. It should be noted that the remote hub 32 may do data processing functions so that not all of the acquired data need be sent to the monitoring or tracking station 12 over the communication network.

The remote hub 32 may also process the received data from sensors and the RFID reader and decide what is important to send. For example, in certain embodiments, the remote hub 32 may determine if an exception, i.e. an unexpected, undesirable or out-of-tolerance condition, is detected in the inventory in an asset. For instance, an exception to the inventory may include missing portions of the inventory (i.e., known inventory that can't be detected) or the presence of unexpected inventory in an asset. This type of exception can occur due to improper loading and unloading of the asset. Thus, the hub 32 may send simply an exception report to the monitoring or tracking station 12 and not the complete response data received from the sensors 18 and the RFID readers 26. Alternatively, it should be noted that, in certain embodiments, the sensors 18 and the RFID readers 26 may be able to communicate with the monitoring station 12 directly over a wired or wireless communication network.

The remote monitoring center 12 is configured to monitor the assets and the inventories based on communication with the hub 32. For example, the monitoring or tracking station 12 receives the processed or analyzed information from the remote hub 32 and conveys the results to the user directly or after further processing or analysis. Alternatively, the monitoring or tracking station 12 may determine the presence and/or the condition of the inventory 16 and/or the location of the asset 14 based on the response data received from the one or more remote hubs 32. Alternatively, as noted above, the monitoring or tracking station 12 may determine the presence, the location and/or the condition of the inventory 16 based on the responses received directly from the sensors 18 and the RFID readers 26. Thus, in certain embodiments, the monitoring or tracking station 12 may process/analyze response received from the RFID reader (directly or through the hub) corresponding to the asset having the inventory to determine the presence of the inventory within that asset.

Moreover, in certain embodiments, the monitoring or tracking station 12 may analyze distribution of weight within the asset and/or loading capacity of the assets based upon the presence/absence of inventories within the assets. For example, if inventories 16 have been unloaded from an asset at a certain point in the supply chain process, the monitoring or tracking station 12 will inform the user that the asset is partially filled and new inventories can be loaded into the asset based on known size and/or weight of the loaded/unloaded inventories. Further, in certain embodiments, the monitoring or tracking station 12 may provide the user with inventory related information (e.g., weight, date of expiration, date of manufacture and so forth) based on a priori information of the identified inventory. Alternatively, such information may be encoded in the RFID tags or labels and can be relayed to the monitoring or tracking station 12. As will be appreciated by those skilled in the art, the monitoring or tracking station 12 may monitor or track the assets and the inventories periodically or upon request.

In certain embodiments, the remote hub 32 and/or the remote monitoring station 12 analyze the sensed parameters and the generated response to determine an anomaly in condition and/or location of the inventories. The anomaly may include diversion of asset from a route or a destination, unauthorized access of the asset (e.g., unexpected door opening event), offloading of inventories at a wrong location, exposure of inventories to harsh conditions (e.g., extreme weather or internal environment, shock, impact, etc.), and so forth. It should be noted that an alarm or flag may be raised upon determining an anomaly. Further, in certain embodiments, the hub 32 and/or the monitoring station 12 may analyze the sensed parameters and the generated response to ensure integrity of the asset or the inventories and/or validate a chain of custody of the asset or the inventories during the entire supply chain process (entire monitoring and tracking period). The integrity of the asset or the inventories may be determined by ensuring no unauthorized access to the asset and/or by ensuring presence of the inventories within the asset. For example, if there are no unexpected door open indications, there is higher faith in the integrity of the inventories. However, if there are unexpected door open indications but no movement of the inventories during that period, there is lesser but still some faith in the integrity of the inventories. Further, if there are unexpected door open indications along with indication about the movement of the inventories out of the asset during that period, there is little or no faith in the integrity of the inventories. Thus, tracking/monitoring includes verifying the presence of the items in the inventory at the time of any door open indication. Similarly, if there are no unexpected route diversion indications for the asset, there is higher faith in the integrity of the asset and the inventories. However, if there are unexpected route diversion indications but no door open indications during that period, there is lesser but still some faith in the integrity of the asset and the inventories. Further, if there are unexpected route diversion indications along with unexpected door open indications during that period, there is little or no faith in the integrity of the asset and the inventories. The chain of custody is therefore established by tracking the asset and proving the continuity of presence of an inventory within the asset during its transit.

In short, an electronic association is made between the tagged inventories 16 being shipped and the RFID readers 26 and the result is transmitted in an automated fashion to the remote monitoring station 12 either directly or via the hub 32. As the inventories 16 are transported from the location of shipment to the destination, updates along the travel route may be recorded automatically and remotely through interrogation of the RFID readers 26. Updates on status or deposition of inventories 16 may then be relayed in a wireless mode to the remote monitoring station 12 and the information may be shared with a client computer system (not shown) or other client communication device (e.g., smart phones, PDAs and so forth). The end users can therefore check in real time the location of their inventories 16 that are tagged with RFID tags 30. It should be noted herein that the architecture of the system 10 is an exemplary embodiment and may vary depending on the requirement.

Status about activity at the assets 14 such as door position, presence of inventories 16, entering or exiting of geofences and so forth are constantly monitored at the monitoring station 12 and/or the remote hub 32 to ensure that the integrity of the inventories has not been compromised. It should be noted that a “geofence” may be referred to as a geographical region that is predefined and used to trigger an event when a user enters or leaves the region. As will be appreciated by those skilled in the art, various kinds of information may be relayed from the hub 32 to the monitoring station 12. Some non-limiting examples of such information may include inventory related data such as real time temperature of the inventory and the physical loads that the inventory is subject to during transport. In another example, the information may be related to condition of the trailer such as tire pressure. In certain embodiments, the position sensing device collects signals from multiple global positioning satellites, calculates the location and relays the location to the remote monitoring center 12. In certain exemplary embodiments, the hub 32 generates a message “geofence entered” or geofence exited” along with location date and time. The message may then be relayed to the remote monitoring center 12. Alerts may be set to notify key people of geofence entered/exited activity.

Additionally, in certain exemplary embodiments, the hub 32 generates a message “door opened” or “door closed” along with location, date, and time. The message may be relayed to the remote monitoring station 12. Alerts can be set to notify whether doors are opened or closed. It should be noted that users may turn on or off door sensors using web interfaces by transmitting commands from the remote monitoring station 12. In certain other exemplary embodiments, the hub 32 generates a message “cargo loaded” or “cargo empty” along with location, date, and time. The message may be relayed to the remote monitoring station 12. Alerts can be set to notify cargo status. Again, it should be noted that users may turn on or off cargo sensors using web interfaces by transmitting commands from the remote monitoring center 12 to the hub 32 provided on the asset. Further, it should be noted that, the information from various sensors 18 may be collectively analyzed for determining the anomaly or verifying chain of custody. For example, door open indications or cargo empty indications while the asset is within a specified geofence may not be considered an anomaly. However, door open indications or cargo empty indications while the asset is outside a specified geofence is an exception that needs attention and may therefore be considered an anomaly.

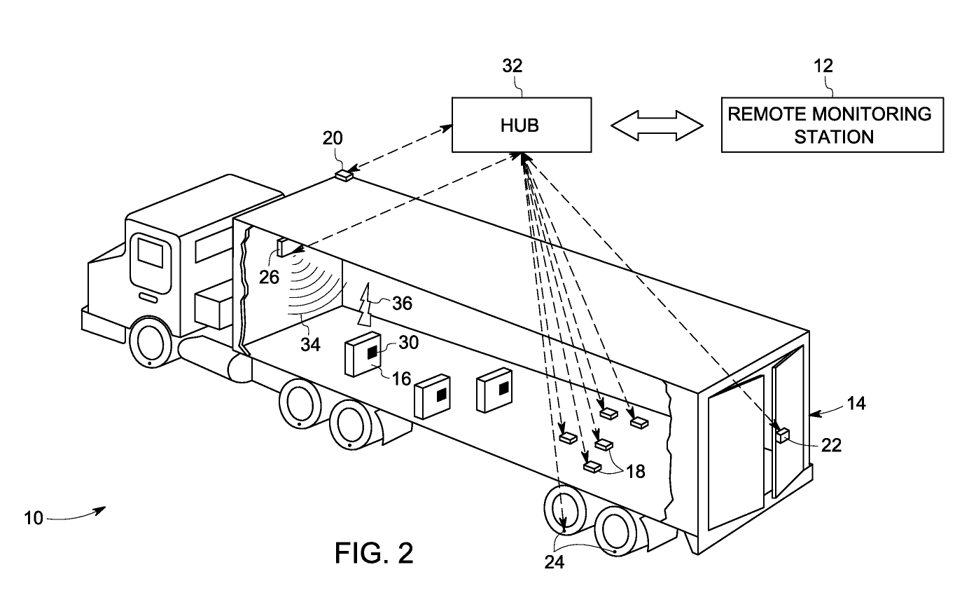

A control scheme 38 for monitoring and tracking inventories 16 within one or more assets 14 via the asset monitoring and tracking system 10 is illustrated in FIG. 3 in accordance with aspects of the present technique. The control scheme 38 includes sensing a plurality of parameters associated with each of the one or more assets at step 40, activating RFID tags attached to the inventories and generating a response based upon the responses received from the RFID tags at step 42, and monitoring and tracking inventories based on the sensed parameters and the generated response at step 44. As will be appreciated by those skilled in the art, the plurality of parameters includes a positional information of the asset. As noted above, the plurality of parameters may further include at least one of a door open/close status, a humidity level, a temperature, a pressure level, a shock, an amount of exposure to light or radiation, a chemical exposure level, and so forth.

As will be appreciated by those skilled in the art, monitoring and tracking inventories comprises analyzing the sensed parameters and the generated response to determine an anomaly in condition and/or location of the inventories. The control scheme 38 may further include the step of generating an alarm or flag upon determining an anomaly. As noted above, such monitoring and tracking of inventories may ensure integrity of the asset or the inventories during entire supply chain process, thereby validating a chain of custody of the inventories. The validation ensures no unauthorized access to the asset has been provided. Additionally, the validation ensures that the inventories were present within the asset throughout the supply chain process (even if in some cases the integrity of the asset is questionable).

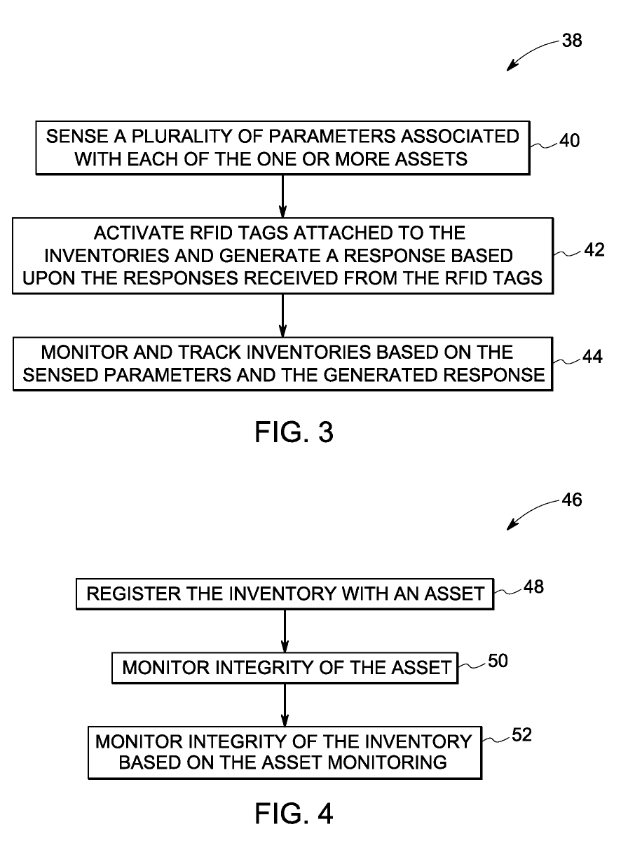

A control scheme 46 for monitoring chain of custody of an inventory via the asset monitoring and tracking system 10 is illustrated in FIG. 4 in accordance with aspects of the present technique. The control scheme 46 includes registering the inventory with an asset at step 48, monitoring integrity of the asset at step 50, and monitoring integrity of the inventory based on the asset monitoring at step 52. As will be appreciated by those skilled in the art, monitoring integrity of the asset comprises tracking the asset and monitoring access to the asset and ensuring that no unauthorized access has been provided to the asset (i.e., no door openings or other integrity faults). Moreover, monitoring integrity of the inventory includes monitoring presence of the inventory within the asset. In particular, the presence needs to be ensured if the integrity of the asset has been compromised at any point in time. In other words, the inventories are monitored to make sure that the tracked piece of inventory is located within the asset at any time even if there is an open door indication or indication of other access to the asset. Thus, the chain of custody of the inventory is validated based upon the monitoring of the asset integrity and the inventory integrity. The validation is done by registering the inventory as being present within the asset during the entire period of monitoring or transit (i.e., during the entire supply chain process).

As will be appreciated by those skilled in the art, the monitoring and tracking system and techniques, described in the various embodiments discussed above, provides supply chain intelligence by enabling real time tracking and/or monitoring of assets and tagged inventories at each step in the supply chain process. For example, the techniques enable a person to know where an inventory is in a supply chain process, specifically in which trailer along with location of the trailer via an intelligent RFID trailer system. The techniques further provide the end user visibility into the capacity in their asset (e.g., trailer).

The system, described in the various embodiments discussed above, is an advanced asset management system that provides not only information about presence of an inventory within an asset (whether the inventory is present or not) but also provides substantially accurate information of location of the asset having the inventory (where the asset is), how full the asset is (how much loaded) and/or what inventories are there. For example, the asset management and tracking system 10 may send real time data of which inventories are in the trailer, the location of the trailer, and of the capacity of the trailer through the GE VeriWise system. Thus, the user can know exactly where each element in their inventory is and in what condition. Hence, the customers are able to track their assets and inventories in real time. As will be appreciated by those skilled in the art, the present technique further provides inventory verification or validation of pickups and deliveries, thereby ensuring that right inventories are loaded on or unloaded from the trailer at the right place. Such systems are specifically useful as more and more trailers are being used as mobile warehouses.

Moreover, as discussed above, a global (wide area) tracking system alone does not suffice, because the integrity of the contents cannot be assured. Similarly, a local identification, such as RFID, alone does not suffice, because the trailer or truck carrying the drugs can be diverted without detection and counterfeit drugs put in place of the actual drugs. The trailer could then be returned to its route, with the counterfeit drugs, and the whole event could go undetected. Thus, there is a need to track at both the local and global (wide area) level to ensure pharmaceutical integrity.

The techniques described in the various embodiments discussed above ensure end-to-end tracking of inventories (e.g., drugs) from manufacturing through distribution to the consumer. The technique couples RFID labeling with mobile asset tracking for complete supply chain transparency, thereby enabling visibility at all points in the process. By integrating a global (wide area) asset monitoring system with local inventory and/or asset identification, complete visibility across the supply chain can be provided and assured. So, by integrating RFID tracking of pharmaceuticals at the item, case or pallet level with a system such as GE VeriWise, which tracks trailers and similar assets using a global communication device, such as a satellite or cellular network, the chain of custody of the pharmaceuticals can be traced from manufacture through to distribution. Moreover, the use of sensors to detect parameters such as door open/close event, temperature, humidity, tire pressure and so forth enhance the security of the monitoring and tracking system 10. The technique enables complete visibility across the supply chain, both at the local and global (wide-area) level, thereby deterring theft, counterfeiting and drug diversion and simplifying authentication

It is to be understood that not necessarily all such advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other advantages as may be taught or suggested herein.

Furthermore, the skilled artisan will recognize the interchangeability of various features from different embodiments. The various features described, as well as other known equivalents for each feature, can be mixed and matched by one of ordinary skill in this art to construct additional systems and techniques in accordance with principles of this disclosure.

Although the systems herein have been disclosed in the context of certain embodiments and examples, it will be understood by those skilled in the art that the invention extends beyond the specifically disclosed embodiments to other alternative embodiments and/or uses of the systems and techniques herein and obvious modifications and equivalents thereof. Thus, it is intended that the scope of the invention disclosed should not be limited by the particular disclosed embodiments described above, but should be determined only by a fair reading of the claims that follow.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for monitoring and tracking inventories within one or more assets, the system comprising:
a plurality of sensors disposed within each of the one or more assets and configured to sense corresponding parameters, the plurality of sensors comprising:
a position sensor configured to receive positional information of the respective asset;
one or more RFID readers configured to communicate with RFID tags attached to the inventories upon being activated and to generate a response; and
a processor in communication with the one or more RFID readers and the plurality of sensors and configured to monitor and track inventories based on the sensed parameters and the generated response and to analyze the sensed parameters and the generated response to ensure integrity and validate a chain of custody of the asset or the inventories during entire period of monitoring and tracking.

2. The system of claim 1, wherein the plurality of sensor further comprises at least one of a door open/close sensor, a humidity sensor, a temperature sensor, a shock sensor, a tire pressure sensor, a radiation sensor, a chemical sensor, or a combination thereof.

3. The system of claim 1, wherein the one or more RFID readers activate one or more antennas located on each of the one or more assets, the one or more antennas configured to receive a response from RFID tags and to relay the response to a corresponding RFID reader upon being activated by the RFID reader.

4. The system of claim 1, wherein the processor is further configured to analyze the sensed parameters and the generated response to determine an anomaly in condition and/or location of the inventories.

5. The system of claim 4, wherein the anomaly comprises at least one of asset being diverted to a different destination, asset being subjected to unauthorized access, inventories being offloaded at a wrong location, inventories being subjected to harsh weather or internal environmental conditions, or a combination thereof.

6. The system of claim 4, wherein the processor is further configured to generate an alarm or flag upon determining an anomaly.

7. The system of claim 1, wherein the processor is configured to ensure integrity of the asset or the inventories by ensuring no unauthorized access to the asset or by ensuring presence of the inventories within the asset.

8. The system of claim 1, wherein the processor is in communication with the one or more RFID readers and the plurality of sensors via a remote hub located on each of the one or more assets.

9. The system of claim 1, wherein the processor is further configured to determine storage capacity of each of the one more assets based on the generated response.

10. A smart asset, comprising:
a plurality of sensors configured to sense corresponding parameters;
one or more RFID readers configured to detect presence of inventories tagged with RFID tags within the smart asset upon being activated and to generate a response upon detection; and
a communication device configured to relay the sensed parameters and the generated response received from the plurality of sensors and the one or more RFID readers to a processor, wherein the processor is configured to analyze the sensed parameters and the generated response to ensure integrity and validate a chain of custody of the asset or the inventories during a supply chain process.

11. The smart asset of claim 10, wherein the plurality of sensor further comprises at least one of a position sensor, a door open/close sensor, a humidity sensor, a temperature sensor, a shock sensor, a tire pressure sensor, a radiation sensor, a chemical sensor, or a combination thereof.

12. The smart asset of claim 10, wherein the processor is further configured to analyze the sensed parameters and the generated response to determine an anomaly in condition and/or location of the inventories.

13. A method of monitoring and tracking inventories within one or more assets, the method comprising:
sensing a plurality of parameters associated with each of the one or more assets, the plurality of parameters comprising a positional information of the asset;
activating RFID tags attached to the inventories and generating a response based upon the responses received from the RFID tags; and
monitoring and tracking inventories based on the sensed parameters and the generated response to ensure integrity and validate a chain of custody of the asset or the inventories during a supply chain process.

14. The method of claim 13, wherein the plurality of parameters further comprises at least one of a door open/close status, a humidity level, a temperature, a pressure level, a shock, an amount of exposure to light or radiation, a chemical exposure level, or a combination thereof.

15. The method of claim 13, wherein monitoring and tracking further comprises analyzing the sensed parameters and the generated response to determine an anomaly in condition and/or location of the inventories.

16. The method of claim 15, further comprising generating an alarm or flag upon determining an anomaly.

17. The method of claim 13, wherein ensuring integrity of the asset or the inventories comprises ensuring no unauthorized access to the asset or ensuring presence of the inventories within the asset.

18. A method of monitoring chain of custody of an inventory, the method comprising:
registering the inventory with an asset;
monitoring integrity of the asset; and
monitoring integrity of the inventory based on the asset monitoring.

19. The method of claim 18, wherein monitoring integrity of the asset comprises tracking the asset.

20. The method of claim 18, wherein monitoring integrity of the asset comprises monitoring access to the asset.

21. The method of claim 18, wherein monitoring integrity of the asset comprises ensuring no unauthorized access to the asset.

22. The method of claim 18, wherein monitoring integrity of the inventory comprises monitoring presence of the inventory within the asset.

23. The method of claim 18, wherein monitoring integrity of the inventory comprises monitoring integrity of the inventory upon compromise of integrity of the asset.

24. The method of claim 18, further comprising validating the chain of custody based upon the monitoring of the asset integrity and the inventory integrity.

25. The method of claim 24, wherein validating the chain of custody comprises registering the inventory as being present within the asset during the entire period of monitoring.
